(19) United States
(12) Patent Application Publication
(10) Pub. No.: US 2004/0059622 A1
(43) Pub. Date: Mar. 25, 2004

(54) Assisting people and computer programs with time and task management

(76) Inventor: Erik T. Mueller, Chevy Chase, MD (US)

Correspondence Address: FREDERICK W. GIBB, III, MCGINN & GIBB, PLLC, 2568-A RIVA ROAD, SUITE 304, ANNAPOLIS, MD, 21401, US

(21) Appl. No.: 10/247,924

(22) Filed: Sep. 20, 2002

(51) Int. Cl. G06F 17/60

(52) U.S. Cl. 705/9

(57) ABSTRACT

Disclosed is a method and system that automatically prompts a user or computer program for tasks, subtasks and supertasks of tasks, expected durations to complete tasks, deadlines, and priorities of the tasks. The invention automatically prompts the user or computer program at regular intervals for the current task and the percentage completion of the task, and sends the user or computer program a message to work on the task if the deadline has passed, informing the user or computer program it is taking longer on the task than the expected duration and in this case also sending the user or computer program a message to work on the supertask of the task, asking the user or computer program to wrap up the task if the task is near completion, and reminding the user or computer program to stay on task if the user or computer program is switching between tasks too quickly.

### BACKGROUND OF THE INVENTION

1. Field of the Invention

The present invention generally relates to devices for improving management of time. More specifically, the invention relates to a system and method that queries, prompts, and advises a person or a computer program in order to improve the time efficiency of that person or computer program.

2. Description of the Related Art

Many people find they do not have enough time. They fill every minute of the day, yet still are unable to do what they need or want to do. They feel they are not spending time doing the things they would like to be doing. The many distractions of modern life make it difficult for them to achieve their goals.

There are several products that have arisen to address the need to help people with time management. One product is self-help books which describe principles of time management to help people understand how to improve their time management. However, people often have trouble remembering the principles and putting the principles in these books into practice.

Another product is the personal digital assistant and similar organizers, which allow the user to enter items into a To Do list. Items can be sorted by priority or filtered by category. The user can add events into a date book and set alarms to remind the user prior to events. However, these products have no notion of what the user is currently working on, do not pro-actively interact with the user, and do not help the user manage time on a minute-to-minute basis.

U.S. Pat. No. 5,861,797 to Becker (1999; “Tactile Reminder Device & Method”), incorporated herein by reference, discloses a wristwatch that is able to vibrate and flash messages. This allows the user to set alarms to remind the user to perform tasks at particular times. The wristwatch also has the ability to vibrate and flash a message such as “PAY ATTN” at variable or fixed intervals. However, such a device provide no guidance as to what the person should pay attention to, or what task the person should work on, wrap up, or stop.

Another example of such products is the Microsoft Project (Microsoft Corporation, Redmond, Wash., USA) and similar computer programs which enable managers to plan and track projects. However, such computer programs rely on team members to enter information such as the hours spent on a task or the percentage completion for a task. Entry is typically performed at the end of each day or week. These programs do not monitor what the user is working on in real time, do not prompt the user for task status information when a task should have been completed, and do not provide minute-to-minute guidance to improve their time management.

### SUMMARY OF THE INVENTION

There is provided, according to one aspect of the invention, a system and method for prompting people to improve their efficiency at tasks, assisting people with time and task management, prompting computer programs to improve their efficiency at tasks, and/or assisting computer programs with time and task management.

The invention discloses a method of improving the efficiency of a user that automatically prompts a user for a task and a deadline for the task. The invention automatically prompts the user at regular intervals for a current user activity and sends the user a message to work on the task if the deadline has expired and the user is not working on the task. The invention also automatically prompts the user for a task duration; and calculates, based on histories of the current user activity, a cumulative time the user has spent on the task. The invention automatically sends the user a message that the user is spending too long on the task if the cumulative time exceeds the task duration. The invention automatically prompts the user for a completion percentage of the task and automatically sends the user a message to wrap up the task if the completion percentage is greater than a predetermined percentage, yet less than 100%. The intent is to wrap up tasks that are almost complete. The invention tracks, based on the current user activity, a number of times the user switches between tasks over a time period and automatically sends the user a message to stay on a specific task if the number of times the user switches between tasks within the time period exceeds a predetermined threshold. The invention sets a reminder at a time to remind the user of the task and then reminds the user of the task at the time.

The invention automatically prompts the user for subtasks of the tasks and automatically prompts the user for deadlines for the subtasks. The invention sends the user a message to work on a subtask if a subtask deadline for the subtask has expired and the user is not working on the subtask. The invention automatically prompts the user for subtask durations; and calculates, based on histories of the current user activity, a cumulative time the user has spent on each of the subtasks. The invention automatically sends the user a message that the user is spending too long on the subtask if the cumulative time for the subtask exceeds a subtask duration for the subtask. The invention automatically prompts the user for a completion percentage of each of the subtasks and automatically sending the user a message to wrap up the subtask if the completion percentage of the subtask is greater than a predetermined percentage, yet less than 100%. The invention automatically prompts a user for a task and a priority for the task. The invention automatically prompts the user at regular intervals for a current user activity and sends the user a message to work on a higher priority task if the higher priority task is incomplete and the user is working on a lower priority task.

The invention also provides a computerized system which includes a client agent that has a graphical user interface adapted to communicate with a user, an executive agent operatively connected to the client agent, and a persistent task storage operatively connected to the executive agent. The executive agent includes a task prompting automaton such that the executive agent is adapted to automatically prompt a user for a task and a deadline of the task, wherein the task and the deadline are stored in the persistent task storage. The executive agent is adapted to automatically prompt the user at regular intervals for a current user activity. The executive agent includes a messaging automaton such that the executive agent is adapted to automatically send the user a message to work on the task if the deadline has expired and the user is not working on the task

The executive agent includes a wrap up automaton such that the executive agent is adapted to automatically prompt the user for a task duration and calculate, based on histories of the current user activity, a cumulative time the user has spent on the task. The invention automatically sends the user a message that the user is spending too long on the task if the cumulative time exceeds the task duration. The executive agent is adapted to automatically prompt the user for a completion percentage of the task and automatically send the user a message to wrap up the task if the completion percentage is greater than a predetermined percentage, yet less than 100%. The executive agent is further adapted to track, based on the current user activity, a number of times the user switches between tasks over a time period. The executive agent includes a stay on task automaton such that the executive agent is adapted to automatically send the user a message to stay on a specific task if the number of times the user switches between tasks within the time period exceeds a predetermined threshold. The executive agent also includes a reminder automaton such that the executive agent is adapted to set a reminder to remind the user of the task.

The task prompting automaton is such that the executive agent is further adapted to automatically prompt the user for subtasks of the task and automatically prompt the user for deadlines for the subtasks. The invention sends the user a message to work on a subtask if a subtask deadline for the subtask has expired and the user is not working on the subtask. The executive agent is further adapted to automatically prompt the user for a completion percentage of each of the subtasks and automatically send the user a message to wrap up the subtask if the completion percentage of the subtask is greater than a predetermined percentage, yet less than 100%.

### BRIEF DESCRIPTION OF THE DRAWINGS

The foregoing and other objects, aspects and advantages will be better understood from the following detailed description of a preferred embodiment(s) of the invention with reference to the drawings, in which:

FIG. 1 is a block diagram illustrating the method of the invention;

FIG. 2 is a flowchart of the general operation of an executive agent;

FIG. 3 is a flowchart of the general operation of a client agent;

FIG. 4 is a drawing of a global finite automaton;

FIG. 5 is a drawing of a global finite automaton;

FIG. 6 is a drawing of a task finite automaton;

FIG. 7 is a drawing of a global finite automaton;

FIG. 8 is a drawing of a task finite automaton;

FIG. 9 is a drawing of a task finite automaton;

FIG. 10 is a drawing of an embodiment of the invention in a desktop application;

FIG. 11 is a drawing of an embodiment of the invention in a portable device;

FIG. 12 is a drawing of an embodiment of the invention used to communicate with a computer program; and

FIG. 13 is a flow diagram that illustrates the tasks of the invention.

### DETAILED DESCRIPTION OF PREFERRED EMBODIMENTS OF THE INVENTION

The invention comprises an automated system that continually and proactively elicits information from people regarding the status of various tasks and of their current activities and reminds people of activities that are not being completed in a timely manner. The invention provides an automated way to give specific time management suggestions that are most appropriate at any given moment.

The invention coordinates information from calendars, To Do lists, planning programs, etc., regarding tasks, task priorities, task due dates, etc. and automatically (and without user intervention) prompts the user regarding the status of one or more tasks as well as the user's current activity. Alternatively, the invention can monitor actively used files and programs to automatically determine a user's current activity. From this information, the invention automatically (and again without user intervention) provides the user with suggestions in order to increase the user's productivity and effectiveness in achieving the user's goals. Therefore, the invention makes timely suggestions to the user to change the user's current activity so that the user can be more effective in achieving the user's specific goals.

The invention prompts the user for task and activity information proactively, which prevents the user from having to remember to enter such information. In addition, the invention issues the prompts for such information at regular intervals that are appropriate with a specific task (or series of tasks). Therefore, the invention can monitor the progress of the various tasks and make suggestions if the current user's activity indicates that the user is working on a lower-priority task or is spending too much time on a given task.

By prompting the user automatically, the invention avoids involving other individuals (managers, co-workers, family members, etc.) and the social stigma that may be involved with individuals being unable to accomplish tasks on their own. Alternatively, the invention can provide suggestions to managers to take management action depending upon subordinate user's responses to the invention's task inquiries.

In addition, by automatically prompting the user, the invention can obtain information at a time when a task or portion of a task should have been completed and provide the user with immediate suggestions that would allow the user to avoid spending too much time on a given task or working on tasks in an inappropriate priority order. This avoids problems that can occur when users enter task status information only at the end of the day or week. The invention provides the ability to pro-actively suggest that a user alter the user's activity at the precise time when a user should change activities, instead of indicating that a user should have changed activity at some point in the past (days or weeks prior).

The invention is useful in many different formats including personal digital assistants (including computerized organizers, cell phones, wristwatches, etc.), computer programs for personal computers, as well as computer programs for larger systems and management teams. The invention increases effectiveness by reminding individuals of task deadlines, priorities, etc., in a timely manner that prevents individuals from wasting their time or using their time ineffectively.

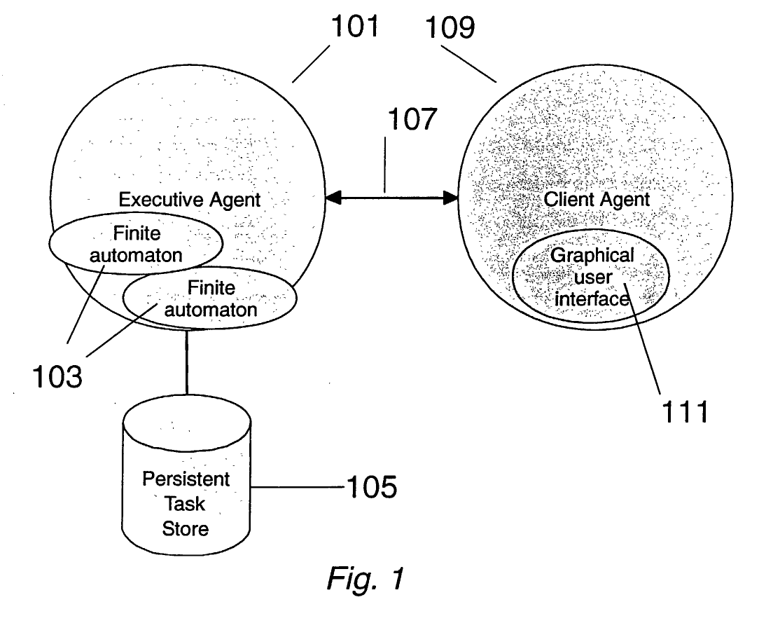

Referring to FIG. 1, an Executive agent 101 has multiple finite automata 103 that store information about tasks in Persistent Task Store 105 and communicate with the Client agent 109 using interprocess communication 107. The Client agent 109 includes a graphical user interface 111.

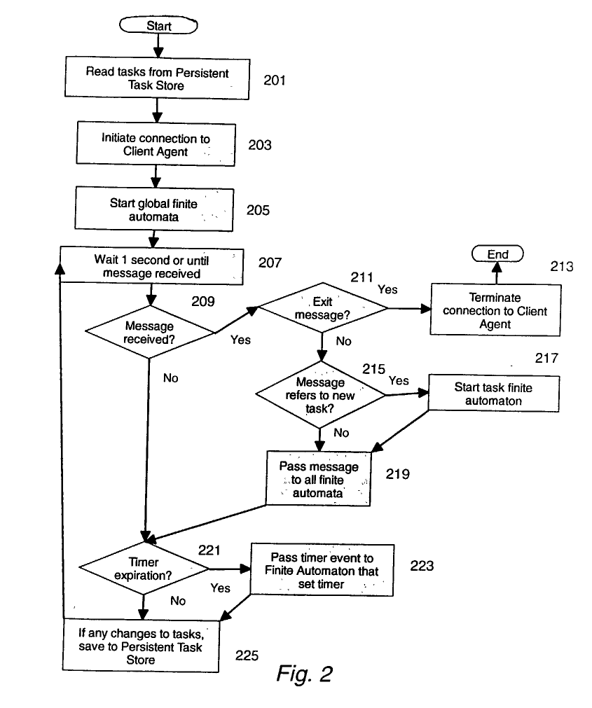

The operation of the Executive agent is shown in FIG. 2. More specifically, in step 201, tasks and their fields are read from the Persistent Task Store 105. In step 203, a communications connection to the Client agent 109 is initiated. In step 205, the global finite automata 103 are started. In step 207, the Executive agent 101 waits a predetermined time period or until a message is received from the Client agent 109. In step 209, it is tested whether a message was received. If so, a branch is taken to step 211. If not, a branch is taken to step 221. In step 211, it is tested whether an <exit!> message was received. If so, a branch is taken to step 213. If not, a branch is taken to step 215. In step 213, the communications connection to the Client agent 109 is terminated. In step 215, it is tested whether the message refers to a new task. If so, a branch is taken to step 217. If not, a branch is taken to step 219. In step 217, the new task is created, the fields of the task are initialized, and the task finite automata are started for the new task.

The fields of a task include whether the task is the task currently being performed (t.current—initial value FALSE), the time the task was created (t.created), the percentage completion of a task (t.progress—initial value 0), whether the task has been completed (t.completed—initial value FALSE), the estimated amount of work time that the task is expected to take (t.dur—initial value NIL), the task deadline (t.deadline—initial value NIL), the supertask of the task (t.supertask—initial value NIL), the time the task was last restarted (t.restart—initial value NIL), the total time spent on the task (t.spent—initial value 0), the time the user should be reminded about the task (t.remind—initial value NIL), and the importance or priority of the task (t.importance—initial value 0.5, indicating an average importance). Thus, the “duration” is the cumulative number of hours expected to be spent working on the task, that is, how many billable hours are estimated by the user to be required to do the task. The “deadline” is the actual date/time the task must be completed by.

FIG. 2 is a flowchart of the operation of the Executive agent, including initialization and termination, communication with the Client agent, management of the finite automata, and management of timers. In step 219, the message is passed to all finite automata for processing. In step 221, it is tested whether a timer has expired. If so, a branch is taken to step 223. If not, a branch is taken to step 225. In step 223, a timer expiration message is passed to the finite automaton that set the timer. In step 225, if any changes have been made to the tasks and their fields since they were last saved in the Persistent Task Store 105, the tasks and their fields are saved to the Persistent Task Store 3. After step 225, a branch is taken back to step 207.

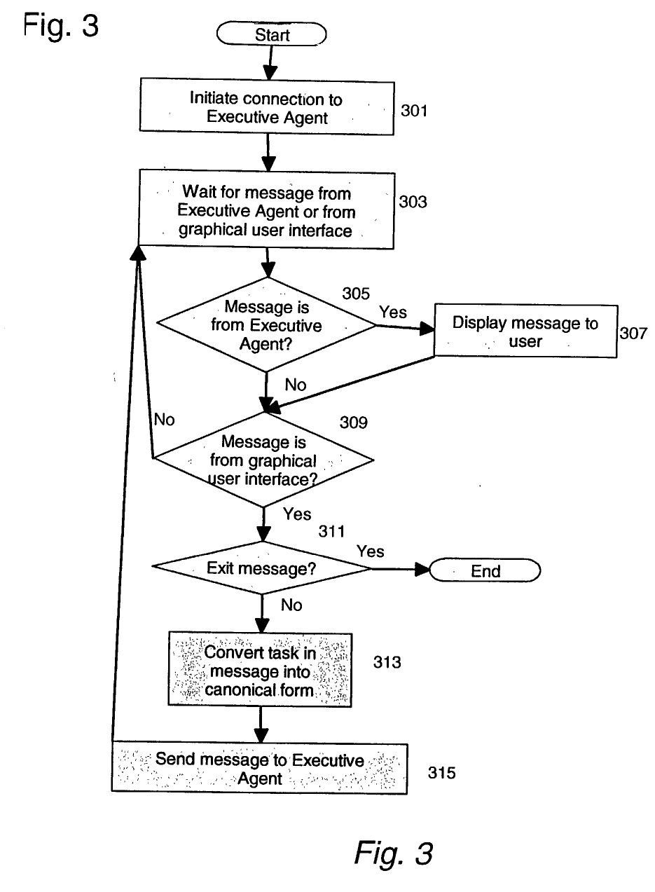

FIG. 3 is a flowchart of the operation of the Client agent, including initialization and termination, communication with the Executive agent, displaying messages to the user via the graphical user interface, and receiving messages from the user via the graphical user interface. More specifically, in step 301, a communications connection to the Executive agent 101 is initiated. In step 303, a message from the Executive agent 101 or graphical user interface 111 is awaited. In step 305, it is tested whether a message was received from the Executive agent 101. If so, a branch is taken to step 307. If not, a branch is taken to step 309. In step 307, the message is displayed to the user. In step 309, it is tested whether a message was received from the graphical user interface 111. If so, a branch is taken to step 311. If not, a branch is taken back to step 301. In step 311, it is tested whether an <exit!> message was received. If so, the flowchart ends. If not, a branch is taken to step 313. In step 313, task names (such as t and t′) in the message are converted into canonical form. In step 315, the message is sent to the Executive agent 101. After step 315, a branch is taken back to step 303.

The invention allows the user to provide a dictionary of synonymous task names. For each group of synonymous task names, one of the task names is canonical. When converting a task name into canonical form, any task name in a group of synonymous task names is converted into the canonical task name. Task names are converted into canonical form by converting to lower case, dropping all non-alphanumeric characters, eliminating redundant spaces, eliminating initial spaces, and eliminated final spaces. Task names are converted into canonical form so that task names will be recognized as identical even if they happen to contain different cases, non-alphanumeric characters, redundant spaces, initial spaces, or final spaces.

A “task formulation” or “task prompting” global finite automaton interacts with the Client Agent 109 to formulate a task. When a <formulate-task!> message is received, a <top-level-task?> message is sent to the user through the graphical user interface 111. When a <top-level-task=,t,dur,deadline> message is received, a <subtask?,t> message is sent, t.dur is set to dur, and t.deadline is set to deadline. When a <subtask=,t,t′,dur′,deadline′> message is received, a <subtask?,t> message is sent, t′.supertask is set to t, t′.dur is set to dur′, and t′.deadline is set to deadline′. Communications can be in a computer communications protocol or in natural language. For example, in such a task formulation automaton, the dialogue between the Executive agent 101 and the user through the graphical user interface 111 of the Client agent 109 could be as follows:

Q: Help me formulate a task. What is the top-level task?

A: The top-level task is writing paper.

Q: What is a subtask of writing paper?

A: A subtask of writing paper is selecting topics.

Q: What is another subtask of writing paper?

A: A subtask of writing paper is doing research.

Q: What is another subtask of writing paper?

A: A subtask of writing paper is drafting paper.

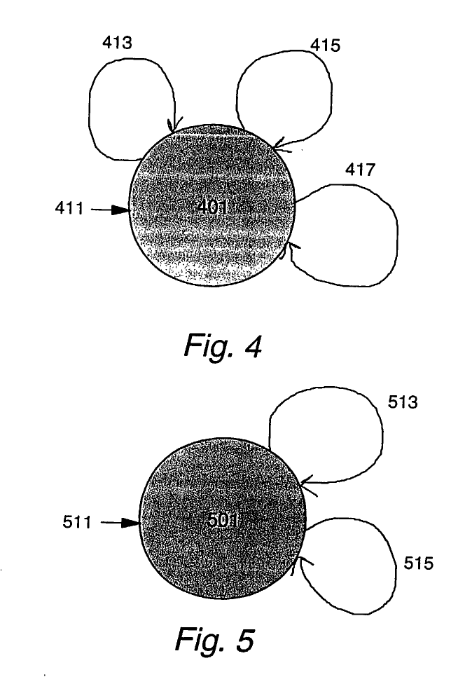

Referring to FIG. 4, the first finite automaton has one state 401. The finite automaton is first started by traversing Arc 411. Arc 413 is traversed when a <formulate-task!> message is received. In this case, a <top-level-task?> message is sent. Arc 415 is traversed when a <top-level-task=,t,dur,deadline> message is received. In this case, a <subtask?,t> message is sent, t.dur is set to dur, and t.deadline is set to deadline. Arc 417 is traversed when a <subtask=,t,t′,dur′,deadline′> message is received. In this case, a <subtask?,t> message is sent, t.subtask is set to t′, t′.supertask is set to t, t′.dur is set to dur′, and t′.deadline is set to deadline′.

A sample dialog produced by this finite automaton is:

c2e|<formulate-task!>

english-c2e|Help me formulate a task

e2c|<top-level-task?>

english-e2c|What is the top-level task?

c2e|<top-level-task=,writing paper,2d,20010515T000000>

english-c2e|The top-level task is writing paper

e2c|<subtask?,writing paper>

english-e2c|What is a subtask of writing paper?

c2e|<subtask=,writing paper,selecting topic,5 h>

english-c2e|A subtask of writing paper is selecting topic

e2c|<subtask?,writing paper>

english-e2c|What is a subtask of writing paper?

c2e|<subtask=,writing paper,doing research,20 h>

english-c2e|A subtask of writing paper is doing research

e2c|<subtask?,writing paper>

english-e2c|What is a subtask of writing paper?

c2e|<subtask=,writing paper,drafting paper, 10 h>

english-c2e|A subtask of writing paper is drafting paper

e2c|<subtask?,writing paper>

english-e2c|What is a subtask of writing paper?

c2e|<subtask=,writing paper,editing paper,5 h>

english-c2e|A subtask of writing paper is editing paper

e2c|<subtask?,writing paper>

english-e2c|What is a subtask of writing paper?

The task formulation automation is continued until all tasks, supertasks, subtasks, etc., are gathered. In addition, the Executive agent 101 is interfaced with an organizer program. When items are entered into the To Do List or Date Book of the organizer program, they are added as tasks in the Executive agent 101. When items are modified in the To Do List or Date Book of the organizer program, their corresponding tasks are modified in the Executive agent 101. When items are deleted from the To Do List or Date Book of the organizer program, their corresponding tasks are deleted in the Executive agent 101. When tasks are added in the Executive agent 101, they are entered into the organizer program. Tasks with remind times or appointment times are entered into the Date Book of the organizer. Other tasks are entered into the To Do List of the organizer. When tasks are modified or deleted in the Executive agent 101, they are modified or deleted in the organizer.

A “current task” or “current user activity” global finite automaton elicits the current task from the Client Agent 109, updates the current and spent fields of the task, and allows the Client Agent 109 to request and receive reminders. A timer is started when the current task global finite automaton is started. When the timer expires, a <current-task?> message is sent and the timer is restarted. When a <current-task=,t> message is returned, the timer is also restarted. A sample dialog produced by this current task global finite automaton is: “What are you doing?” and “I am currently working on doing web research.” More specifically, referring to FIG. 5, the next finite automaton has one state 501. A timer is started when the finite automaton is started 511. Arc 513 is traversed when the timer expires. In this case, a <current-task?> message is sent and the timer is started. Arc 515 is traversed when a <current-task=,t> message is received. In this case, the timer is restarted. A sample dialog produced by this finite automaton is:

msg-e2c|<current-task?>

english-e2c|What are you doing?

msg-c2e|<current-task=,doing web research>

english-c2e|I am currently working on doing web research

When a <current-task=,t> message is received, if t.current is false, t.restart is set to the current time and t.current is set to true. When a <current-task=,t′> message where t′!=t is received, t.current is set to false and t.spent is set to t.spent+(the current time—t.restart). Again referring to FIG. 5, the next finite automaton has one state. Arc 513 is traversed when a <current-task=,t> message is received. In this case, if t.current is false, t.restart is set to the current time and t.current is set to true. Arc 517 is traversed when a <current-task=,t′> message where t′!=t is received. In this case, t.current is set to false and t.spent is set to t.spent+(the current time—t.restart).

In a “reminder” automaton, when a <remind!,t,remind> message is received, t.remind is set to remind. When the timer expires, the timer is started and if the current time is greater than or equal to t.remind, a <reminder=,t> message is sent and t.remind is set to NIL. A sample dialog produced by this finite automaton is “Remind me about eating lunch at 20010427T120300” and “I am reminding you about eating lunch.” Referring again to FIG. 5, the next finite automaton has one state. A timer is started when the finite automaton is started 511. Arc 513 is traversed when a <remind!,t,remind> message is received. In this case, t.remind is set to remind. Arc 515 is traversed when the timer expires. In this case, the timer is started and if the current time is greater than or equal to t.remind, a <reminder=,t> message is sent and t.remind is set to NIL. A sample dialog produced by this finite automaton is:

msg-c2e|<remind! ,eating lunch,20010427T120300>

english-c2e|Remind me about eating lunch at 20010427T120300

msg-e2c|<reminder=,eating lunch>

english-e2c|I am reminding you about eating lunch

A “task duration” finite automaton elicits information about the estimated duration of work time that the task is expected to take from the Client Agent 109. A timer is started when the task duration finite automaton is started. When the timer expires, if t.dur is NIL a <dur?,t> message is sent. When a <dur=,t,dur> message is received, t.dur is set to dur. Additional automatons provide similar information for the deadline, importance, and supertask fields of the task. A sample dialog produced by this finite automaton is:

Q: What is the task of doing web reseach? What are you doing?

A: The task of doing web research is selecting topic.

Q: When is the deadline for doing web research?

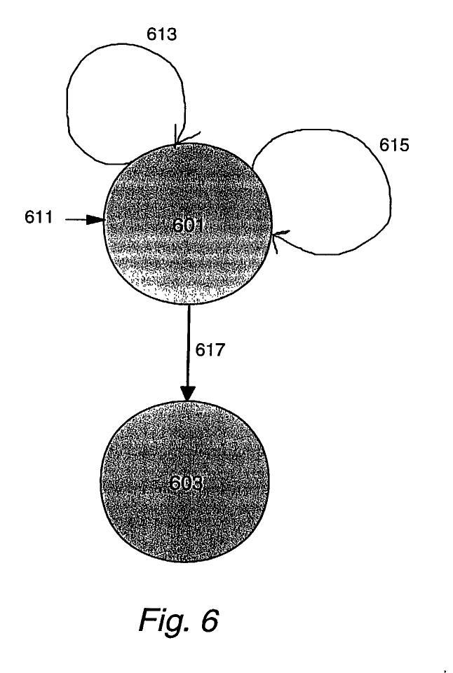

More specifically, referring to FIG. 6, the next finite automaton has two states 601 and 603. A timer is started when the finite automaton is started 611. Arc 613 is traversed from 601 to 601 when the timer expires. In this case, if t.dur is NIL a <dur?,t> message is sent. Arc 615 is traversed from 601 to 601 when a <dur=,t,dur> message is received. In this case, t.dur is set to dur. Arc 617 is traversed from 601 to 603 when a <completed=,t> message is received. Additional arcs not shown provide similar behavior for the deadline, importance, and supertask fields of the task. A sample dialog produced by this finite automaton is:

msg-e2c|<supertask?,doing web research>

english-e2c|What is the task of doing web research?

msg-e2c|<current-task?>

english-e2c|What are you doing?

msg-c2e|<supertask=,doing web research,selecting topic>

english-c2e|The task of doing web research is selecting topic

msg-e2c|<deadline?,doing web research>

english-e2c|When is the deadline for doing web research?

A “stay on task” global finite automaton informs the Client Agent 109 when it is switching from task to task too quickly, and the global finite automaton suggests periodically to the Client Agent 109 what task it should be working on. When a <current-task=,t> message is received, if the rate of switching tasks over a given time period (THRASHMIN minutes) is greater than predetermined allowable rate of switching (THRASHRATE), a <stay-on-task!> message is sent. For example if the Client Agent 109 provided the following responses within a given period of time “I am currently working on doing web research. I am currently working on changing a tape. I am currently working on answering phone. I am currently working on reading newspaper.” The Executive Agent would respond “Stay on task.”

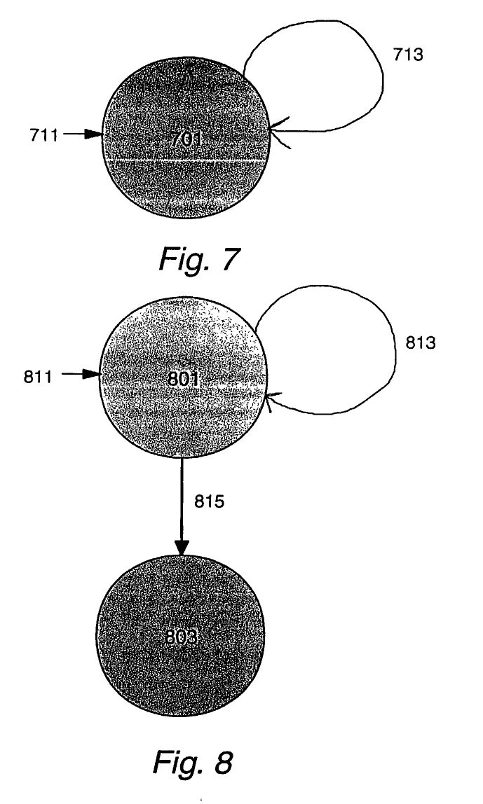

More specifically, referring to FIG. 7, the next finite automaton has one state 701. The finite automaton is started by traversing Arc 711. Arc 713 is traversed when a <current-task=,t> message is received. In this case, if the rate of switching tasks over the last THRASHMIN minutes is greater than THRASHRATE, a <stay-on-task!> message is sent. A sample dialog produced by this finite automaton is:

msg-c2e|<current-task=,doing web research>

english-c2e|I am currently working on doing web research

msg-c2e|<current-task=,changing a tape>

english-c2e|I am currently working on changing a tape

msg-c2e|<current-task=,answering phone>

english-c2e|I am currently working on answering phone

msg-c2e|<current-task=,reading newspaper>

english-c2e|I am currently working on reading newspaper

msg-e2c|<stay-on-task!>

english-e2c|Stay on task

The invention can also provide an automaton where a <do!,t> message is sent where t is the noncompleted task with the highest weight, where t.weight=t.importance+urgency, where urgency=((t.dur—t.spent)*(current time−t.created))/(max(1,t.spent)*max(1,t.deadline−current time)). This weight calculation assigns a greater weight to more important tasks and a greater weight to more urgent tasks. Urgency is calculated such that tasks are urgent to the extent that they are both far from completion and close to or past the deadline.

Referring again to FIG. 7, the next finite automaton has one state. A timer is started when the finite automaton is started 711. Arc 713 is traversed when the timer expires. In this case, a <do!,t> message is sent where t is the noncompleted task with the highest weight, where t.weight=t.importance+urgency, where urgency=((t.dur−t.spent)*(current time−t.created))/(max(1,t.spent)*max(1,t.deadline−current time)). A sample dialog produced by this finite automaton is:

msg-e2c|<do!,writing paper>

english-e2c|Do writing paper

A “wrap up” automaton informs the Client Agent 109 when it is spending too much time on a task. When a timer expires and t.current is true and t.spent is greater than a predetermined time limit (OVERSPENT) times t.dur., a <taking-too-long,t> message is sent. Alternatively, after the <taking-too-long,t> message is sent, a <do!,t′> message is sent where t′ is the supertask of the task t that is taking too long. The invention monitors the progress of a task and informs the Client Agent 109 when it should wrap up a task. Thus, the invention automatically sends the Client Agent 109 a message to wrap up a task if the percentage of the task that is complete is less that the percentage of time allotted for that task that has expired or if a predetermined portion of the time allotted for the task has expired.

More specifically, referring to FIG. 8, the next finite automaton has two states 801 and 803. A timer is started when the finite automaton is started 811. Arc 813 is traversed from 801 to 801 when the timer expires and t.current is false or t.spent is less than or equal to OVERSPENT times t.dur. In this case, the timer is started. Arc 815 is traversed from 801 to 803 when the timer expires and t.current is true and t.spent is greater than OVERSPENT times t.dur. In this case, a <taking-too-long,t> message is sent. A sample dialog produced by this finite automaton is:

msg-c2e|<subtask=,doing web research,looking into product a,1 m>

english-c2e|A subtask of doing web research is looking into product a

msg-c2e|<current-task=,looking into product a>

english-c2e|I am currently working on looking into product a

msg-e2c|<taking-too-long,looking into product a>

english-e2c|You are taking too long looking into product a

msg-e2c|<do!,doing web research>

english-e2c|Do doing web research

msg-c2e|<current-task=,looking into product a>

When a <current-task=,t> message is received, a timer is started. When a <current-task=,t′> message where t′=t is received, the timer is stopped. When the timer expires, a <progress?,t> message is sent and the timer is restarted. When a <progress=,t,progress> message is received and progress is less than or equal to a measure of completion ? NEARCOMPLETION is a percentage (such as 0.95 or 95%) above which a task is considered to be nearing completion (NEARCOMPLETION), t.progress is set to progress. When a <progress=,t,progress> message is received and progress is greater than NEARCOMPLETION, t.progress is set to progress. When a <current-task=,t′> message where t′!=t is received, a <wrap-up!,t> message is sent. When a <completed,t> message is received, t.completed is set to TRUE. A sample dialog produced by this finite automaton is:

A: I am currently working on looking into product b.

Q: How far along are you with looking into product b?

A: I am 50 percent done looking into product b.

Q: How far along are you with looking into product b?

A: I am 98 percent done looking into product b. I am currently working on looking into product c.

Q: Wrap up looking into product b.

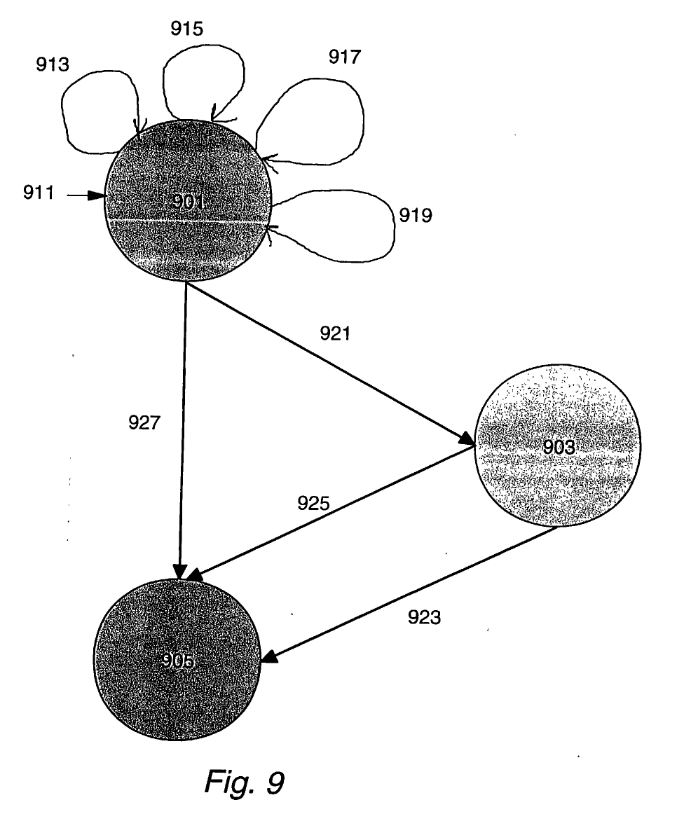

More specifically, referring to FIG. 9, the next finite automaton has three states 901, 903, and 905. The finite automaton is started by traversing Arc 911. Arc 913 is traversed from 901 to 901 when a <current-task=,t> message is received. In this case, the timer is (re)started. Arc 915 is traversed from 901 to 901 when a <current-task=,t′> message where t′=t is received. In this case, the timer is stopped. Arc 917 is traversed from 901 to 901 when the timer expires. In this case, a <progress?,t> message is sent and the timer is started. Arc 919 is traversed from 901 to 901 when a <progress=,t,progress> message is received and progress is less than or equal to NEARCOMPLETION. In this case, t.progress is set to progress. Arc 921 is traversed from 901 to 903 when a <progress=,t,progress> message is received and progress is greater than NEARCOMPLETION. In this case, t.progress is set to progress. Arc 923 is traversed from 903, to 905 when a <current-task=,t′> message where t′!=t is received. In this case, a <wrap-up!,t> message is sent. Arc 925 is traversed from 903 to 905 when a <completed,t> message is received. In this case, t.completed is set to TRUE. Arc 927 is traversed from 901 to 905 when a <completed,t> message is received. In this case, t.completed is set to TRUE. A sample dialog produced by this finite automaton is:

msg-c2e|<current-task=,looking into product b>

english-c2e|l am currently working on looking into product b

msg-e2c|<progress?,looking into product b>

english-e2c|How far along are you with looking into product b?

msg-c2e|<progress=,looking into product b,50%>

english-c2e|I am 50 percent done looking into product b

msg-e2c|<progress?,looking into product b>

english-e2c|How far along are you with looking into product b?

msg-c2e|<progress=,looking into product b,98%>

english-c2e|I am 98 percent done looking into product b

msg-c2e|<current-task=,looking into product c>

english-c2e|I am currently working on looking into product c

msg-e2c|<wrap-up!,looking into product b>

english-e2c|Wrap up looking into product b

The above parameters are initially set to default values, but may be modified by the user. For example, the default values could be: THRASHMIN=5, THRASHRATE=15, OVERSPENT=2, and NEARCOMPLETION=0.95. Similarly, the timer durations are initially set to default values and may be modified by the user. The task hierarchy is displayed to the user. A graphical user interface is provided for editing the hierarchy. The Executive agent 101 keeps track of appointments and the second finite automaton discussed in reference to FIG. 7 takes appointments into account. If an appointment t is scheduled for the current time, a <do!,t> message is sent. The second finite automaton discussed in reference to FIG. 7 invokes external scheduling software such as Microsoft Project to determine what task the Client agent 109 should work on.

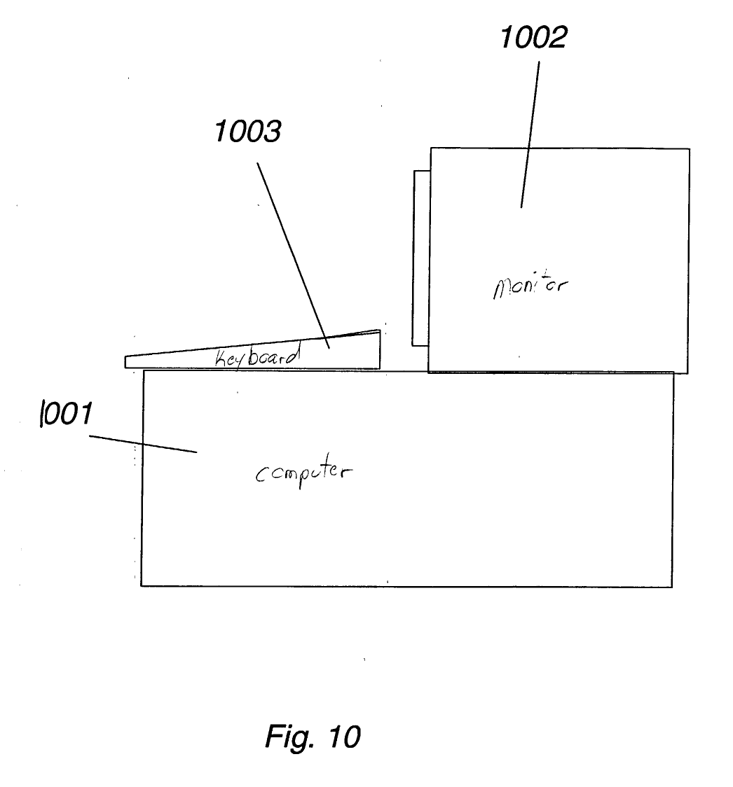

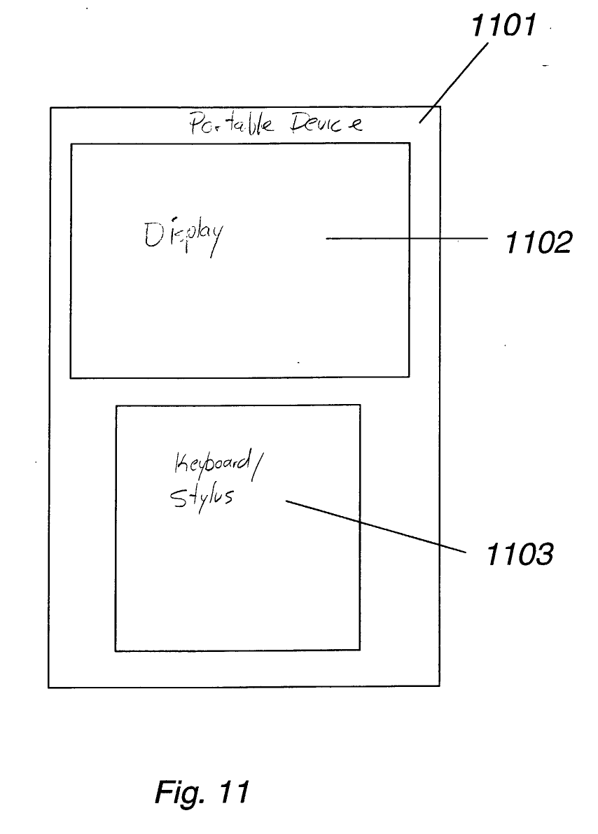

The invention can be embodied as a desktop application as shown in FIG. 10, comprising a computer 1001, monitor 1002, and keyboard 1003. The invention can also be embodied as a portable device as shown in FIG. 11, comprising a portable device 1101, display 1102, and keyboard or stylus tap area 1103.

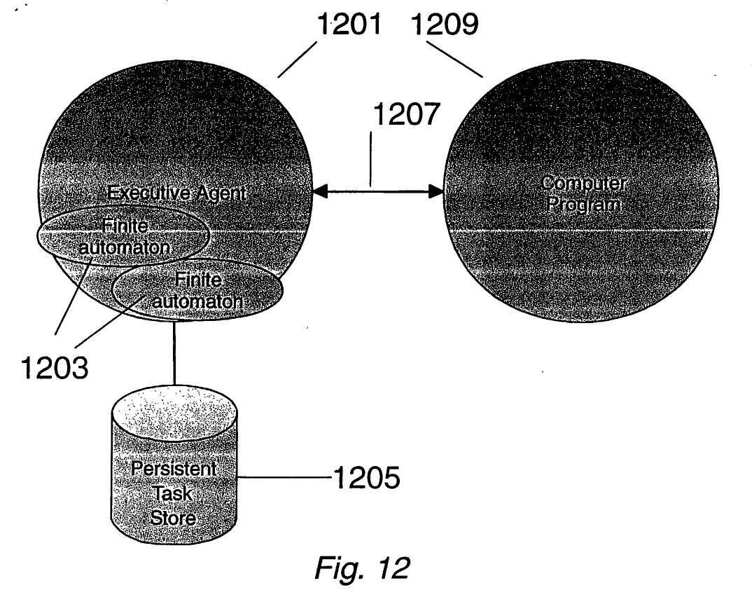

In an alternative, referring to FIG. 12, the Client agent 1209 can lack the graphical user interface for interacting with a person. The Client agent 1209 can be a Computer Program that performs multiple tasks and that wishes to improve its time efficiency. For example, the Client agent 1209 may be an artificial intelligence program. The Executive agent 1201 comprises multiple finite automata 1203 that store information about tasks in Persistent Task Store 1205 and communicate with the Computer Program 1209 using interprocess communication 1207.

In contrast to Microsoft Project, which is useful for managing teams working on a project on a large time scale, the invention is useful for managing the efficiency of an individual working on a project on a minute-by-minute basis. For example, even if a team member is using Microsoft Project to manage work on a large scale, the invention is useful for managing the team member's own efficiency on a fine-grained basis.

Attention Deficit Disorder (ADD) affects about 3 percent of all adults in the United States. People with ADD have trouble formulating tasks, staying focused on tasks, monitoring the passage of time, avoiding excessive creation of subtasks, knowing when to stop tasks, and stopping tasks. The invention helps people with ADD formulate, stick to, complete, and stop tasks, and avoid spending too much time on subtasks.

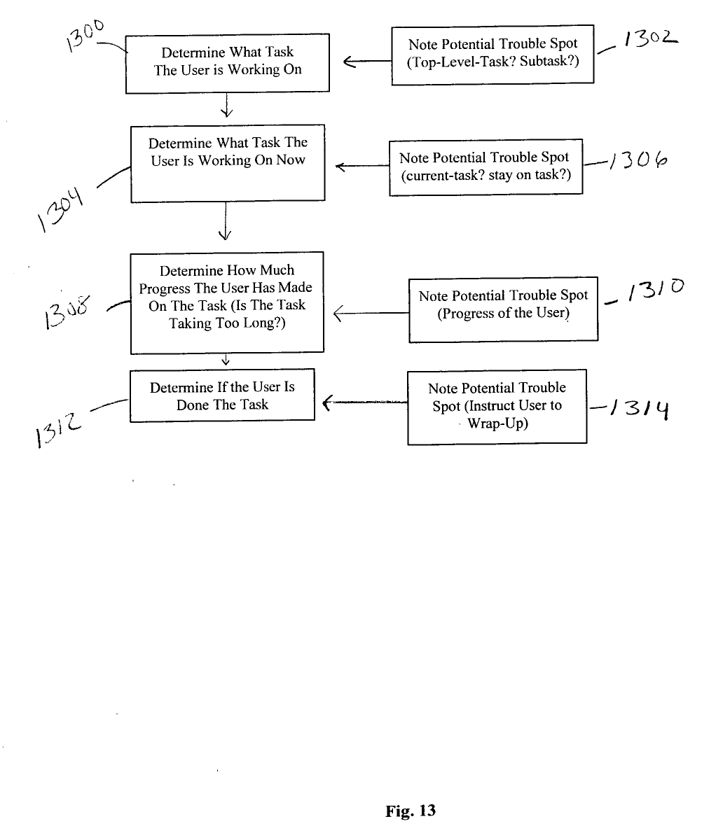

FIG. 13 illustrates a flow diagram of the invention. In item 1300, the invention first determines what task the user should work on. Next, in item 1302, the invention notes to the user that this is a potential trouble spot (top-level-task? subtask?). In item 1304, the invention determines what task the user is currently working on. The invention notes another potential trouble spot for the user in item 1306 (current-task? stay-on-task!). In item 1308, the invention determines how much progress the user has made on the task and determines if the task is taking too long. In item 1310, the invention notes another potential trouble spot regarding the progress of the user. Next, in item 1312, the invention determines if the task has been completed by the user. Item 1314 notes another potential trouble spot for the user and instructs the user to wrap-up the task.

The same invention used to monitor and improve the efficiency of people can be used to monitor and improve the efficiency of computer programs. Computer programs, like people, are constrained by limited resources such as CPU power. For any automated task that is broken down into subtasks (such as conducting automated web searches or making inferences in an artificial intelligence program) it is useful not to get bogged down performing subtasks rather than achieving the top-level task. The invention helps a computer program achieve the top-level task given limited resources.

While the invention has been described in terms of preferred embodiments, those skilled in the art will recognize that the invention can be practiced with modification within the spirit and scope of the appended claims.

What is claimed is:

1. A method of improving the efficiency of a user, said method comprising:
automatically prompting a user for a task and a deadline for said task;
automatically prompting said user at regular intervals for a current user activity; and
sending said user a message to work on said task if said deadline has expired and said user is not working on said task.

2. The method in claim 1, further comprising automatically prompting said user for a task duration;
calculating, based on histories of said current user activity, a cumulative time said user has spent on said task; and
automatically sending said user a message that said user is spending too long on said task if said cumulative time exceeds said task duration.

3. The method in claim 1, further comprising automatically prompting said user for a completion percentage of said task and automatically sending said user a message to wrap up said task if said completion percentage is greater than a predetermined percentage, yet less than 100%.

4. The method in claim 1, further comprising:
tracking, based on said current user activity, a number of times said user switches between tasks over a time period; and
automatically sending said user a message to stay on a specific task if said number of times said user switches between tasks within said time period exceeds a predetermined threshold.

5. The method in claim 1, further comprising:
setting a reminder at a time to remind said user of said task; and
reminding said user of said task at said time.

6. The method in claim 1, further comprising:
automatically prompting said user for subtasks of said task;
automatically prompting said user for deadlines for said subtasks; and
sending said user a message to work on a subtask if a subtask deadline for said subtask has expired and said user is not working on said subtask.

7. The method in claim 6, further comprising automatically prompting said user for subtask durations;
calculating, based on histories of said current user activity, a cumulative time said user has spent on each of said subtasks; and
automatically sending said user a message that said user is spending too long on said subtask if said cumulative time for said subtask exceeds a subtask duration for said subtask.

8. The method in claim 6, further comprising automatically prompting said user for a completion percentage of each of said subtasks and automatically sending said user a message to wrap up said subtask if said completion percentage of said subtask is greater than a predetermined percentage, yet less than 100%.

9. A method of improving the efficiency of a user, said method comprising:
automatically prompting a user for a task and a priority for said task;
automatically prompting said user at regular intervals for a current user activity; and
sending said user a message to work on a higher priority task if said higher priority task is incomplete and said user is working on a lower priority task.

10. The method in claim 9, further comprising automatically prompting said user for a task duration;
calculating, based on histories of said current user activity, a cumulative time said user has spent on said task; and
automatically sending said user a message that said user is spending too long on said task if said cumulative time exceeds said task duration.

11. The method in claim 9, further comprising automatically prompting said user for a completion percentage of said task and automatically sending said user a message to wrap up said task if said completion percentage is greater than a predetermined percentage, yet less than 100%.

12. The method in claim 9, further comprising:
tracking, based on said current user activity, a number of times said user switches between tasks over a time period; and
automatically sending said user a message to stay on a specific task if said number of times said user switches between tasks within said time period exceeds a predetermined threshold.

13. The method in claim 9, further comprising:
setting a reminder at a time to remind said user of said task; and
reminding said user of said task at said time.

14. The method in claim 9, further comprising:
automatically prompting said user for subtasks of said task;
automatically prompting said user for deadlines for said subtasks; and
sending said user a message to work on a subtask if a subtask deadline for said subtask has expired and said user is not working on said subtask.

15. The method in claim 14, further comprising automatically prompting said user for subtask durations;
calculating, based on histories of said current user activity, a cumulative time said user has spent on each of said subtasks; and
automatically sending said user a message that said user is spending too long on said subtask if said cumulative time for said subtask exceeds a subtask duration for said subtask.

16. The method in claim 14, further comprising automatically prompting said user for a completion percentage of each of said subtasks and automatically sending said user a message to wrap up said subtask if said completion percentage of said subtask is greater than a predetermined percentage, yet less than 100%.

17. A method of improving the efficiency of a user using a computerized system, said method comprising:
automatically prompting a user for tasks, deadlines of said tasks, and priorities of said tasks;
automatically prompting said user at regular intervals for a current user activity; and
sending said user a message to work on a higher priority task if a deadline for said higher priority task has expired and said user is not working on said higher priority task.

18. The method in claim 17, further comprising automatically prompting said user for a task duration;
calculating, based on histories of said current user activity, a cumulative time said user has spent on said task; and
automatically sending said user a message that said user is spending too long on said task if said cumulative time exceeds said task duration.

19. The method in claim 17, further comprising automatically prompting said user for a completion percentage of said task and automatically sending said user a message to wrap up said task if said completion percentage is greater than a predetermined percentage, yet less than 100%.

20. The method in claim 17, further comprising:
tracking, based on said current user activity, a number of times said user switches between tasks over a time period; and
automatically sending said user a message to stay on a specific task if said number of times said user switches between tasks within said time period exceeds a predetermined threshold.

21. The method in claim 17, further comprising:
setting a reminder at a time to remind said user of said task; and
reminding said user of said task at said time.

22. The method in claim 17, further comprising:
automatically prompting said user for subtasks of said task;
automatically prompting said user for deadlines for said subtasks; and
sending said user a message to work on a subtask if a subtask deadline for said subtask has expired and said user is not working on said subtask.

23. The method in claim 17, further comprising automatically prompting said user for subtask durations;
calculating, based on histories of said current user activity, a cumulative time said user has spent on each of said subtasks; and
automatically sending said user a message that said user is spending too long on said subtask if said cumulative time for said subtask exceeds a subtask duration for said subtask.

24. The method in claim 17, further comprising automatically prompting said user for a completion percentage of each of said subtasks and automatically sending said user a message to wrap up said subtask if said completion percentage of said subtask is greater than a predetermined percentage, yet less than 100%.

25. A method of improving the efficiency of a computer program, said method comprising:
automatically prompting a computer program for a task and a deadline for said task;
automatically prompting said computer program at regular intervals for a current computer program activity; and
sending said computer program a message to work on said task if said deadline has expired and said computer program is not working on said task.

26. The method in claim 25, further comprising automatically prompting said computer program for a task duration;
calculating, based on histories of said current computer program activity, a cumulative time said computer program has spent on said task; and
automatically sending said computer program a message that said computer program is spending too long on said task if said cumulative time exceeds said task duration.

27. The method in claim 25, further comprising automatically prompting said computer program for a completion percentage of said task and automatically sending said computer program a message to wrap up said task if said completion percentage is greater than a predetermined percentage, yet less than 100%.

28. The method in claim 25, further comprising:
tracking, based on said current computer program activity, a number of times said computer program switches between tasks over a time period; and
automatically sending said computer program a message to stay on a specific task if said number of times said computer program switches between tasks within said time period exceeds a predetermined threshold.

29 The method in claim 25, further comprising:
setting a reminder at a time to remind said computer program of said task; and
reminding said computer program of said task at said time.

30. The method in claim 25, further comprising:
automatically prompting said computer program for subtasks of said task;
automatically prompting said computer program for deadlines for said subtasks; and
sending said computer program a message to work on a subtask if a subtask deadline for said subtask has expired and said computer program is not working on said subtask.

31. The method in claim 30, further comprising automatically prompting said computer program for subtask durations;
calculating, based on histories of said current computer program activity, a cumulative time said computer program has spent on each of said subtasks; and
automatically sending said computer program a message that said computer program is spending too long on said subtask if said cumulative time for said subtask exceeds a subtask duration for said subtask.

32. The method in claim 30, further comprising automatically prompting said computer program for a completion percentage of each of said subtasks and automatically sending said computer program a message to wrap up said subtask if said completion percentage of said subtask is greater than a predetermined percentage, yet less than 100%.

33. A computerized system comprising:
a client agent having a graphical user interface adapted to communicate with a user;
an executive agent operatively connected to said client agent; and
a persistent task storage operatively connected to said executive agent,
wherein said executive agent includes a task prompting automaton such that said executive agent is adapted to automatically prompt a user for a task and a deadline of said task, wherein said task and said deadline are stored in said persistent task storage,
wherein said executive agent includes a current user activity automaton such that said executive agent is adapted to automatically prompt said user at regular intervals for a current user activity; and
wherein said executive agent includes a messaging automaton such that said executive agent is adapted to automatically send said user a message to work on said task if said deadline has expired and said user is not working on said task.

34. The system in claim 33, wherein said executive agent includes a wrap up automaton such that said executive agent is adapted to automatically prompt said user for a task duration;
calculate, based on histories of said current user activity, a cumulative time said user has spent on said task; and
automatically send said user a message that said user is spending too long on said task if said cumulative time exceeds said task duration.

35. The system in claim 33, wherein said executive agent includes a wrap up automaton such that said executive agent is adapted to automatically prompt said user for a completion percentage of said task and automatically send said user a message to wrap up said task if said completion percentage is greater than a predetermined percentage, yet less than 100%.

36. The system in claim 33, wherein said executive agent is further adapted to track, based on said current user activity, a number of times said user switches between tasks over a time period; and
wherein said executive agent includes a stay on task automaton such that said executive agent is adapted to automatically send said user a message to stay on a specific task if said number of times said user switches between tasks within said time period exceeds a predetermined threshold.

37. The system in claim 33, wherein said executive agent includes a reminder automaton such that said executive agent is adapted to:
set a reminder at a time to remind said user of said task; and
remind said user of said task at said time.

38. The system in claim 33, wherein said task prompting automaton is such that said executive agent is further adapted to:
automatically prompt said user for subtasks of said task;
automatically prompt said user for deadlines for said subtasks; and
send said user a message to work on a subtask if a subtask deadline for said subtask has expired and said user is not working on said subtask.

39. The system in claim 38, wherein said executive agent is further adapted to automatically prompt said user for a completion percentage of each of said subtasks and automatically send said user a message to wrap up said subtask if said completion percentage of said subtask is greater than a predetermined percentage, yet less than 100%.

40. A program storage device readable by machine, tangibly embodying a program of instructions executable by the machine to perform a method of improving the efficiency of a user, said method comprising:
automatically prompting a user for a task and a deadline for said task;
automatically prompting said user at regular intervals for a current user activity; and
sending said user a message to work on said task if said deadline has expired and said user is not working on said task.

41. The program storage device in claim 40, wherein said method further comprises automatically prompting said user for a task duration;
calculating, based on histories of said current user activity, a cumulative time said user has spent on said task; and
automatically sending said user a message that said user is spending too long on said task if said cumulative time exceeds said task duration.

42. The program storage device in claim 40, wherein said method further comprises automatically prompting said user for a completion percentage of said task and automatically sending said user a message to wrap up said task if said completion percentage is greater than a predetermined percentage, yet less than 100%.

43. The program storage device in claim 40, wherein said method further comprises:
tracking, based on said current user activity, a number of times said user switches between tasks over a time period; and
automatically sending said user a message to stay on a specific task if said number of times said user switches between tasks within said time period exceeds a predetermined threshold.

44. The program storage device in claim 40, wherein said method further comprises:
setting a reminder at a time to remind said user of said task; and
reminding said user of said task at said time.

45. The program storage device in claim 40, wherein said method further comprises:
automatically prompting said user for subtasks of said task;
automatically prompting said user for deadlines for said subtasks; and
sending said user a message to work on a subtask if a subtask deadline for said subtask has expired and said user is not working on said subtask.

46. The program storage device in claim 45, wherein said method further comprises automatically prompting said user for subtask durations;
calculating, based on histories of said current user activity, a cumulative time said user has spent on each of said subtasks; and
automatically sending said user a message that said user is spending too long on said subtask if said cumulative time for said subtask exceeds a subtask duration for said subtask.

47. The program storage device in claim 45, wherein said method further comprises automatically prompting said user for a completion percentage of each of said subtasks and automatically sending said user a message to wrap up said subtask if said completion percentage of said subtask is greater than a predetermined percentage, yet less than 100%.
